(19) United States
(12) Patent Application Publication
(10) Pub. No.: US 2002/0059125 A1
(43) Pub. Date: May 16, 2002

(54) Method and mobile terminal for keeping income and expense

(76) Inventor: Tatsuaki Okamura, Tokyo (JP)

Correspondence Address: McGinn & Gibb, PLLC, Suite 200, 8321 Old Courthouse Road, Vienna, VA, 22182-3817, US

(21) Appl. No.: 09/986,424

(22) Filed: Nov. 8, 2001

(30) Foreign Application Priority Data
Nov. 10, 2000 (JP) 2000-343019

(51) Int. Cl. G06F 17/60

(52) U.S. Cl. 705/35

(57) ABSTRACT

A mobile terminal receives an e-mail from a number of withdrawal sources through a communications network. The e-mail indicates an expected amount to be withdrawn from a bank savings account of the owner of the mobile terminal. In response to the e-mail, the mobile terminal stores the amount indicated in the e-mail in an expected expense memory. The mobile terminal has a savings memory in which an exact copy of the amount saved in the bank savings account is stored. The mobile terminal also receives an e-mail from the bank which identifies a withdrawal source and indicates an amount withdrawn from the savings account. In response to this e-mail, the mobile terminal updates the savings memory with the amount indicated therein and an amount equal to the indicated amount is transferred from the expected expense memory to an expense record memory.

### BACKGROUND OF THE INVENTION

1. Field of the Invention

The present invention relates generally to electronic commerce and more specifically to a method and mobile terminal for keeping income and expense through a communications network such as the Internet.

2. Description of the Related Art

Keeping amounts of income and expense for precision analysis for home economy requires constant monitoring on incomes and withdrawals automatically performed on one's bank savings account as well as on the amount of cash paid for daily purchases. Although accounting software is currently available, manual input of the receipt data of the purchases into the user's computer is a cumbersome and time-consuming task, and inevitably entails human errors. Access to the homepage of user's bank for enquiry for income and expense also needs manual transfer to an account book.

Japanese Patent Publication 8-161269 discloses an electronic household account book. Although the known account book is a handheld device, the known device is not designed for operation with a communications network. Hence, input data must be manually entered through a keypad.

Therefore, there exists a need for a method and device for receiving monetary data from the network without human intervention.

### SUMMARY OF THE INVENTION

It is therefore an object of the present invention to provide a method and mobile terminal for keeping income and expense of a person substantially without human intervention.

According to a first aspect of the present invention, there is provided a method of keeping income and expense of a person in a mobile terminal having a savings memory. The method comprises the steps of storing, in the savings memory, an amount currently saved in a bank's savings account of the person, receiving from the bank an e-mail identifying a withdrawal source and indicating an amount withdrawn from the savings account, and updating the savings memory with the amount indicated in the e-mail.

Preferably, the mobile terminal further includes an expected expense memory and an expense record memory. The method further comprises the steps of receiving from one of a plurality of withdrawal sources, an e-mail indicating an expected amount to be withdrawn from the savings account, storing the expected amount in the expected expense memory, and transferring from the expected expense memory an amount equal to the amount indicated in the e-mail received from the bank to the expense record memory.

According to a second aspect, the present invention provides a mobile terminal comprising a wireless interface for establishing a communication link through a communications network to income and withdrawal sources, a savings memory for storing an amount currently saved in a bank savings account of an owner of the mobile terminal, and control circuitry connected to the interface for receiving an e-mail which identifies a withdrawal source and indicates an amount withdrawn from the savings account, and updating the savings memory with the indicated amount.

Preferably, the mobile terminal further includes an expected expense memory and an expense record memory. The control circuitry receives from one of a plurality of withdrawal sources an e-mail indicating an expected amount of payment to be withdrawn from the bank savings account of the owner, stores the indicated amount of payment in the expected expense memory, and transfers from the expected expense memory an amount equal to the amount indicated in the e-mail received from the bank to the expense record memory.

### BRIEF DESCRIPTION OF THE DRAWIGNS

The present invention will be described in detail further with reference to the following drawings, in which:

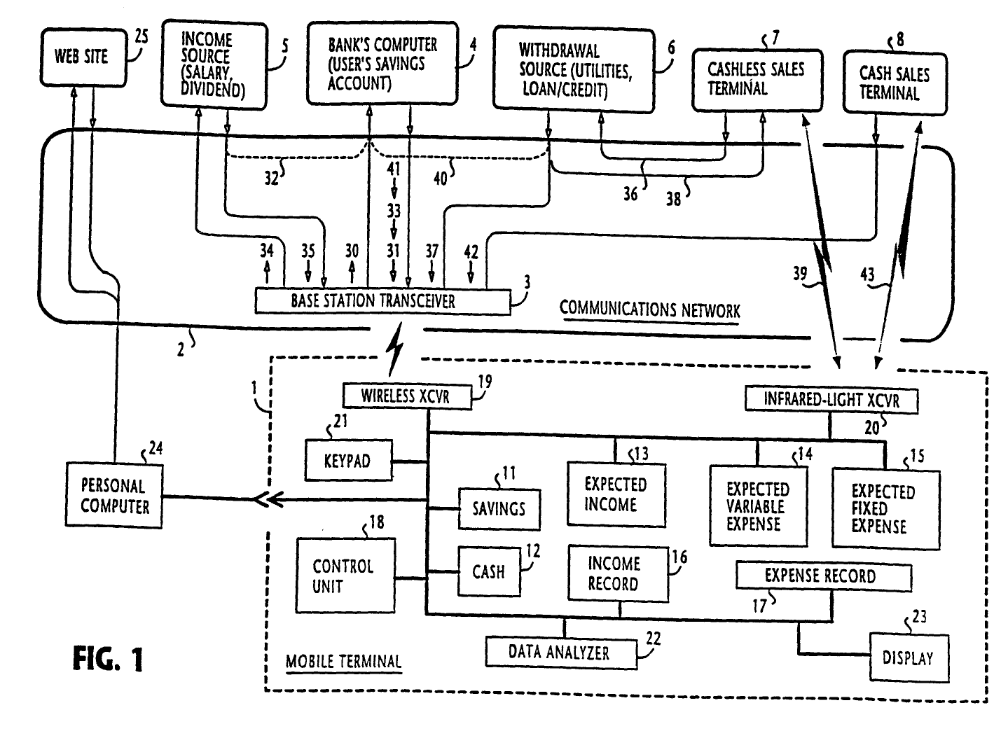

FIG. 1 is a block diagram of a hand-held mobile terminal connected to a communications network for receiving income and expense data from a number of income and withdrawal sources and settling household or personal accounts;

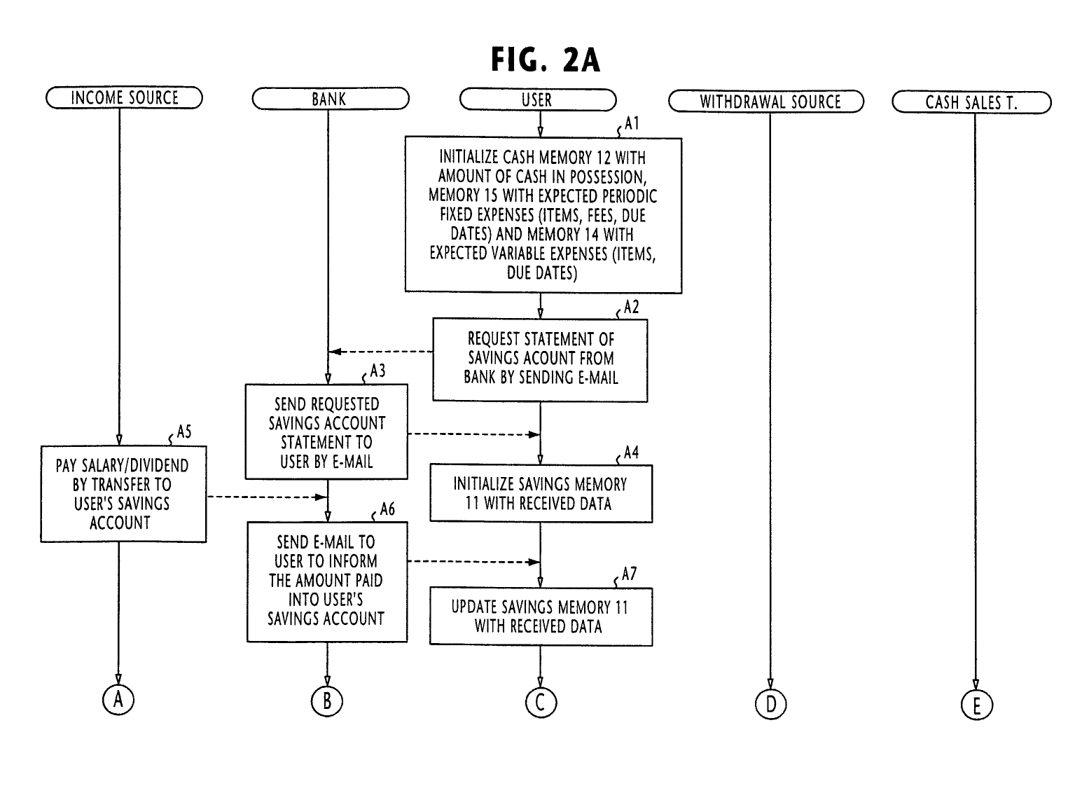

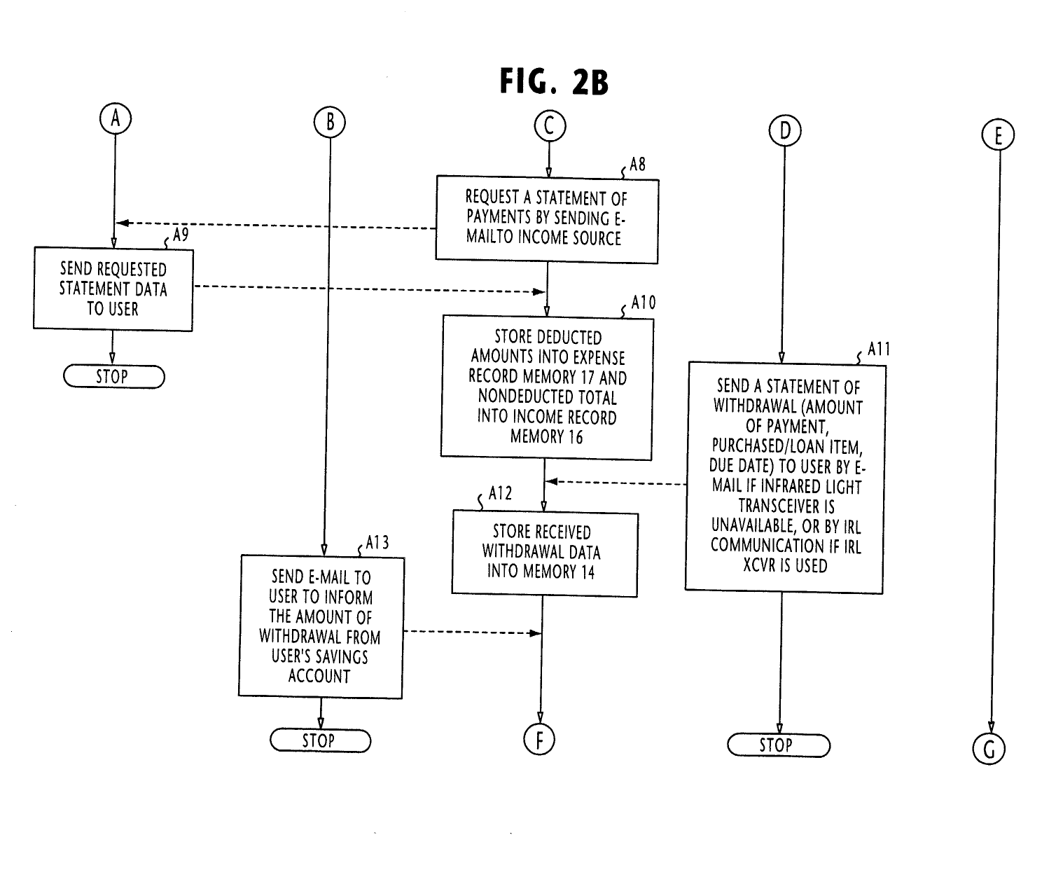

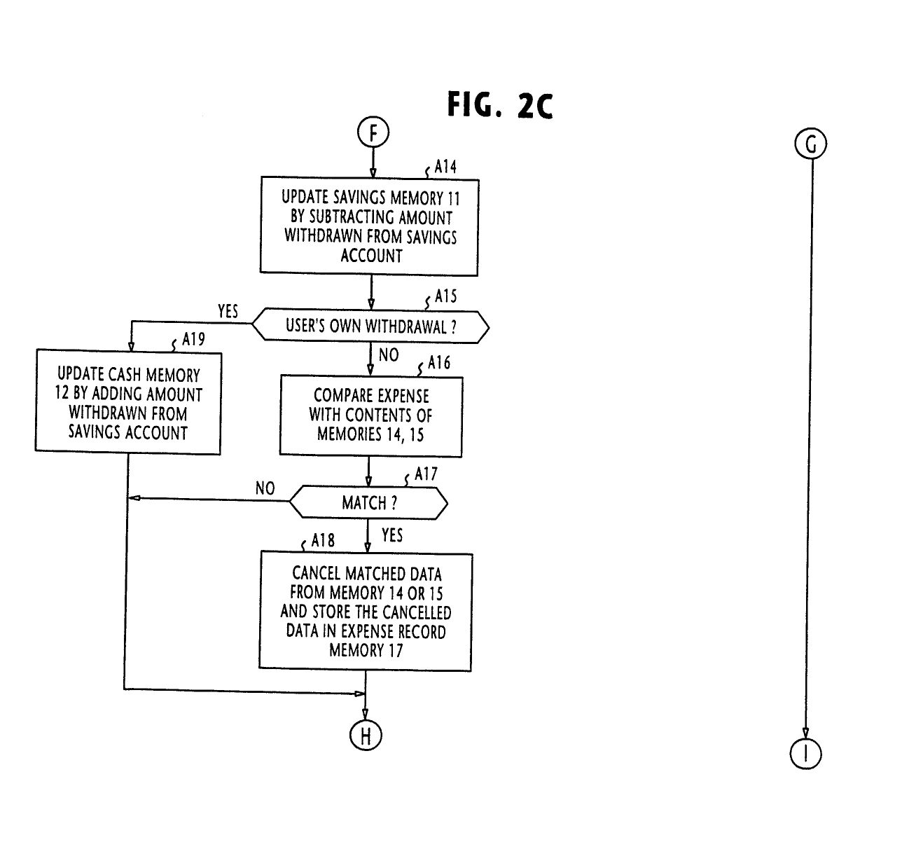

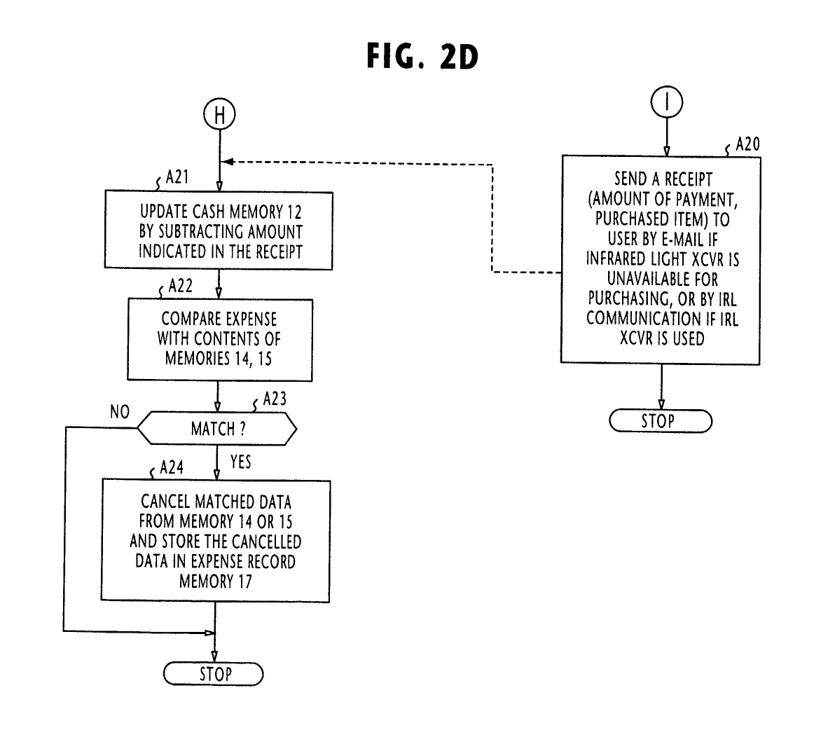

FIGS. 2A, 2B, 2C and 2D are flowcharts of the operation of the mobile terminal; and

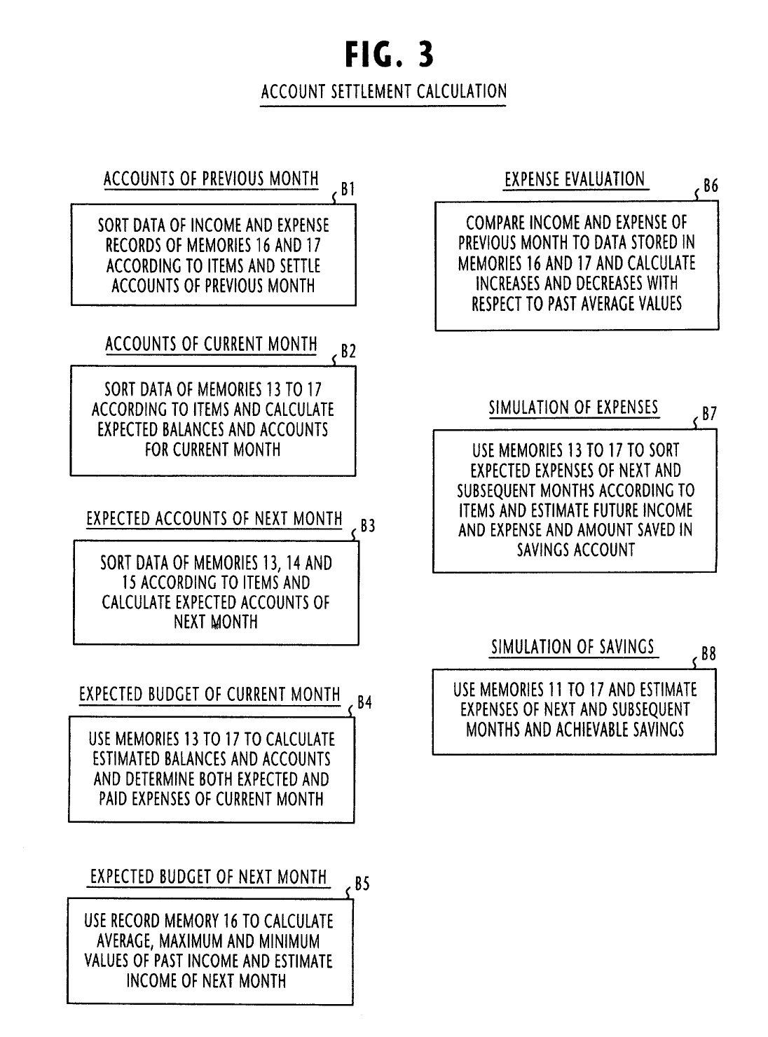

FIG. 3 shows routines performed by the accounting module based on data stored in memories of the mobile terminal.

### DETAILED DESCRIPTION

Referring to FIG. 1, an electronic mobile accounting system of the present invention is illustrated. The system is comprised of a user's mobile terminal 1 and a communications network 2. A base station transceiver 3 of a cellular mobile network forms part of the communications network 2.

To the communications network 2 are connected a plurality of computers, including a computer 4 of a bank in which the user's savings account is maintained, a computer 5 of user's income source such as the user's employer or a company of which the user is a stockholder. Income source 5 is connected through the network 2 to the bank's computer 4 to pay salary or dividend into the user's bank account. A withdrawal source 6, which is a computer of such organizations as public utilities (gas, water, electricity and telephones), insurance or loan/credit company, is also connected to the network. If the withdrawal source is a loan/credit company, it receives signals from a cashless sales terminal 7 and sends a statement of withdrawal for a purchase or a borrowing with an e-mail. If the mobile terminal uses an infrared-light communication to access the cashless sales terminal, the withdrawal source 6 sends the statement to the user through the same means of communication. A cash sales terminal 8 is also connected to the network 2 to issue a “receipt” by sending an e-mail to the mobile terminal 1. If sales terminals 7 and 8 are provided with an infrared light transceiver, they establish communication with the user through an infrared light transceiver 20 of the mobile terminal.

Mobile terminal 1 includes a number of memories whose read/write operations are under the control of a CPU 18. These memories are classified into fund memories, expected accounts memories and record memories. The fund memories include a savings memory 11 and a cash memory 12 for storing a user's bank savings and a current amount of user's cash, respectively. The expected accounts memories include an expected income memory 13, an expected variable expense memory 14 and an expected fixed expense memory 15. Expected income memory 13 is used to store an expected amount of income such as payment for work and dividend deposited into the user's bank account. Expected variable expense memory 14 stores an expected but unpredictable amounts of expenses such as payments for bills from the public utilities, and the expected fixed expense memory 15 stores an expected fixed amounts of expenses such as fees for subscribed periodicals. The record memories include an income record memory 16 and an expense record memory 17 for maintaining past records of incomes and expenses, respectively.

Control unit 18 is responsive to signals received by a wireless transceiver 19 from the communications network 2 or signals received by the infrared light transceiver 20 from the sales terminal 7 or 8. A keypad 21 is used to enter user's data into memories 11 and 12.

A data analyzer 22 is used to provide settlement of accounts by using data stored in memories 11 to 17 in a manner as will be described. Data entered through the keypad 21 or data obtained by the data analyzer 22 are displayed on a display panel 23.

A personal computer 24 may be coupled to the hand-held mobile terminal 1 as a back-up device or as a terminal for accessing an accounting web site 25 through the network 2.

The operation of the control unit 18 proceeds as shown in the flowcharts of FIGS. 2A to 2D.

At the beginning of the operation (step Al), the user manipulates the keypad 21 to initialize the cash memory 12 with the amount of cash he is currently in possession, the memory 14 with expected variable expenses (such as utilities fees) according to items and due dates, and the memory 15 with expected fixed expenses (such as payments for subscribed periodicals and housing loan) according to items, fees and due dates.

Mobile terminal 1 requests a statement of his savings account from the bank by sending an e-mail 30 from the wireless transceiver 19, which is routed through the network 2 to the bank's computer 4 (step A2). In response, the bank's computer 4 returns the requested savings account statement to the user with an e-mail 31, which is routed through the network to the mobile terminal 1 (step A3).

Mobile terminal 1 responds to the e-mail 31 from the bank's computer by initializing its savings memory 11 with the amount currently saved in the user's bank account (step A4).

When the income source 5 pays the user's salary or dividend into the user's bank account as indicated by a dotted line 32 in FIG. 1 (step A5), an email 33 is transmitted from the bank computer 4 to the user, indicating the amount paid from the income source 5 to the user's bank account (step A6). Mobile terminal 1 updates the savings memory 11 with the income data from the bank (step A7).

In response to the communication from the bank, the mobile terminal requests a statement of payments from the income source 5 by sending an email 34 through the network (step A8). Income source 5 returns the requested statement with an e-mail 35 (step A9).

At step A10, the mobile terminal 1 examines the contents of the e-mail 35 and stores deducted amounts into the expense record memory 17 and non-deducted amounts into the income record memory 16.

If the withdrawal source 6 receives a communication 36 from the cashless sales terminal 7 indicating that a user's purchase or a burrowing occurs, it sends a statement of expected withdrawal from the user's bank account to the mobile unit 1 with an e-mail 37. If infra-red light is used between the mobile terminal 1 and the cashless sales terminal 7 for transactions, the withdrawal source 6 sends the statement of withdrawal to the cashless sales terminal 7 by a communication 38. In response, the sales terminal 7 retransmits the received statement to the mobile terminal over an infrared-light path 39. In addition, the e-mail 37 is also transmitted from the withdrawal source 6 when the public utilities companies periodically issue a statement of expected withdrawal from the user's bank account.

If the mobile terminal 1 receives the statement of withdrawal by the email 37 or through the infrared-light path 39 (step All), it stores the received withdrawal data into the expected variable expense memory 14 (step A12).

When the due date of a user's unsettled payment arrives the withdrawal sources 6 withdraws that payment from the user's savings account as indicated by a dotted line 40. When this occurs, the bank computer 4 informs the user of the settled payment withdrawn from his bank account by sending an e-mail 41 through the network to the mobile terminal 1 (step A13). A withdrawal notification e-mail 41 is also transmitted from the bank computer 4 when the user himself makes a withdrawal from his bank savings account.

Mobile terminal 1 responds to the e-mail 41 by updating its savings memory 11 with the amount indicated in the received e-mail (step A14). Thus, a payment settled in the user's bank savings account is also settled in the savings memory 11 and there is an exact match between the savings memory 11 and the user's bank savings account.

Mobile terminal 1 analyzes the contents of the withdrawal source indicated in the received e-mail 41 and determines whether the withdrawal notification is due to his own withdrawal from his bank savings account (step A15). If so, the mobile terminal proceeds to step A19 to update the cash memory 12 by adding the amount indicated in the e-mail 41.

If the withdrawal source identified by the e-mail 41 is other than the user (owner) of the mobile terminal, the mobile terminal determines that the withdrawal is due to the settlement of some utility or loan/credit bill and flow proceeds from step A15 to step A16 for making comparisons between the contents of the e-mail 41 and the contents of memories 14 and 15 for a match. If the item, the amount withdrawn and the due date indicated in the received e-mail 41 coincide with those in one of the entries of these memories (step A17), the matched entry is cancelled in that memory and transferred to the expense record memory 17 (step A18).

In FIG. 2D, if the user makes a purchase with the cash sales terminal 8, the latter sends a receipt of the purchase to the user with an e-mail 42 if infrared-light communication means are not available. If the infrared-light interface is provided in the cash sales terminal 8, the receipt is sent via an infrared-light path 43 to the mobile terminal (step A20). The transmitted receipt indicates the amount paid for the purchase and identifies the purchased item.

In response to the receipt of the purchase from the sales terminal 8, the mobile terminal proceeds to step A21 to update the cash memory by subtracting the amount indicated in the receipt from the stored current value. Mobile terminal 1 then executes steps A22 to A24 which correspond in significance to steps A16 to A18 of FIG. 2C.

Preferably, the e-mail received from the network 2 is written in a data format that can be treated as a visual text for display as well as in a data format that can be read into an accounting software program. The data read into the accounting software program should include an amount, type (income or expense) and date of transaction.

It is seen from the foregoing that wherever the user goes carrying the mobile terminal of the present invention, he is able to ascertain the contents of his savings account and the amount of cash in current possession and updates its savings and cash memories at all times. Further, the storage of expected withdrawals in the expected expense memories 14 and 15 allows the user to make an accurate plan for future allowable expenses when a withdrawal occurs. In addition, the deducted amounts stored in the expense record memory 17 serves to contrast the amount of income stored in the savings memory 11.

Data analyzer 22 uses data stored in the memories 11 to 17 to perform a number of routines as illustrated in FIG. 3.

In routine B1, the data analyzer 22 sorts data stored in the income and expense record memories 16 and 17 according to items and settles accounts of previous month. In routine B2, the data analyzer 22 sorts data stored in the memories 13, 14, 15, 16 and 17 according to items and calculates expected balances and counts for current month. In routine B3, the data analyzer 22 sorts data stored in the memories 13, 14 and 15 and calculates expected accounts of next month. In routine B4, the data analyzer 22 uses data stored in the memories 13, 14, 15, 16 and 17 to calculate estimated balances and accounts and determines both expected and paid expenses of current month. In routine B5, the record memory 16 is used to calculate average, maximum and minimum values of past income data, and an expected income of next month is estimated. In routine B6, data stored in the memories 16 and 17 of the previous month are compared with each other, and increases and decreases with respect to past average values are calculated as an evaluation of expenses.

In routine B7, a simulation of expenses is provided. In this routine, data in memories 13 to 17 are referenced and expected expenses of next and subsequent months are sorted according to different items and future income and expense and an amount saved in the users' bank savings account are estimated.

In routine B8, a simulation of savings amount is performed by referencing all memories 11 to 17. Based on the income and expense data, expenses expected for the next and subsequent months and an expected savings amount that can be achieved are determined.

Data stored in the mobile terminal 1 may be copied and downloaded to the personal computer 24 as a precaution against possible loss of data from the mobile terminal. Using the computer's keyboard, the user can edit the downloaded data. In addition, the user can make the most of the computing power of the personal computer 24 for making an accurate analysis of the downloaded data. To this end, the computer 24 establishes a connection to the web site 25 through the network, where the data is analyzed by expertise and the results of analysis are sent to the computer 24.

Based on the analysis by experts, the computer 24 may issue a warning signal to the user with respect to each item of planned expenses when the current expense of each item is likely exceed its expected value.

What is claimed is:

1. A method of keeping income and expense of a person in a mobile terminal having a savings memory, comprising the steps of:
storing, in said savings memory, an amount currently saved in a bank's savings account of said person;
receiving from the bank an e-mail identifying a withdrawal source and indicating an amount withdrawn from said savings account; and
updating said savings memory with the amount indicated in the email.

2. The method of claim 1, wherein said mobile terminal further includes an expected expense memory and an expense record memory, further comprising the steps of:
receiving from one of a plurality of withdrawal sources, an e-mail indicating an expected amount to be withdrawn from said savings account;
storing said expected amount in said expected expense memory; and
transferring from said expected expense memory an amount equal to the amount indicated in the e-mail received from said bank to said expense record memory.

3. The method claim 2, wherein said mobile terminal includes an infrared-light interface, and wherein one of said withdrawal sources is associated with a cashless sales terminal, further comprising the steps of:
sending a signal via said infrared-light interface to said cashless sales terminal when a purchase is made with a credit card;
receiving a signal via the infrared-light interface which has been communicated from said associated withdrawal source to said cashless sales terminal, the received signal identifying said associated withdrawal source and indicating an expected amount of payment to be withdrawn from said savings account for said purchase; and
updating said expected expense memory with the expected amount indicated in said received signal.

4. The method claim 1, further comprising the steps of:
storing an amount of cash in a cash memory;
receiving an e-mail from a cash sales terminal when a purchase is made with said cash sales terminal, the e-mail identifying the purchase and indicating an amount paid for the purchase; and
updating said cash memory with the amount indicated in the received e-mail and storing the indicated amount in said expense record memory.

5. The method of claim 4, further comprising the step of updating said cash memory with the amount indicated in the e-mail from said bank if the identified withdrawal source is said person.

6. The method claim 1, wherein said mobile terminal includes an infrared-light interface and communicates with a cash sales terminal using the infrared-light interface when a purchase is made, further comprising the steps of:
storing an amount of cash in a cash memory;
receiving a signal from said cash sales terminal via said infrared-light interface, the signal identifying said purchase and indicating an amount paid for the purchase; and
updating said cash memory with an amount indicated in the received signal and storing the indicated amount in said expense record memory.

7. The method of claim 1, further comprising the steps of:
receiving from said bank an e-mail which identifies an income source and indicates an amount of income and an amount deducted from the amount of income; and
updating said savings memory with the amount of income and storing the deducted amount in said expense record memory.

8. The method of claim 1, further comprising the steps of:
transmitting a request signal to said bank;
receiving from said bank an e-mail which indicates an amount currently saved in said savings account; and
storing the amount indicated in the received e-mail into said savings memory.

9. The method of claim 1, wherein each of the e-mails is written in a data format readable as a visual text for display and in a data format readable by an accounting software program.

10. The method of claim 9, wherein the data readable by the accounting software program includes an amount, type (income or expense) and date of transaction.

11. The method of claim 1, further comprising the steps of storing past income data into an income record memory and analyzing the stored past income data to produce an estimate of expected future income.

12. The method of claim 1, further comprising the step of analyzing data stored in said expense record memory to produce an estimate of expected future expense.

13. A mobile terminal comprising:
a wireless interface for establishing a communication link through a communications network to income and withdrawal sources;
a savings memory for storing an amount currently saved in a bank savings account of an owner of the mobile terminal; and
control circuitry connected to said interface for receiving an e-mail which identifies a withdrawal source and indicates an amount withdrawn from said savings account, and updating said savings memory with the indicated amount.

14. The mobile terminal of claim 13, further comprising:
an expected expense memory; and
an expense record memory,
said control circuitry receiving from one of a plurality of withdrawal sources an e-mail indicating an expected amount of payment to be withdrawn from the bank savings account of said owner, storing the indicated amount of payment in said expected expense memory, and transferring from said expected expense memory an amount equal to the amount indicated in the e-mail received from said bank to said expense record memory.

15. The mobile terminal of claim 14, further comprising:
an infrared-light interface;
said control circuitry sending a signal via said infrared-light interface to a cashless sales terminal associated with one of said plurality of withdrawal sources when a purchase is made with a credit card, receiving a signal via the infrared-light interface which is communicated from said associated withdrawal source to said cashless sales terminal, the received signal identifying the withdrawal source and indicating an expected amount of payment to be withdrawn from said savings account for said purchase.

16. The mobile terminal of claim 14, further comprising a cash memory,
said control circuitry storing an amount of cash in said cash memory, receiving an e-mail from a cash sales terminal when a purchase is made with said cash sales terminal, the e-mail identifying said purchase and indicating an amount paid for said purchase, and updating said cash memory with the amount indicated in the received e-mail and storing the indicated amount in said expense record memory.

17. The mobile terminal of claim 16, wherein said control circuitry further performs updating said cash memory with the amount indicated in the second e-mail if the identified withdrawal source is said owner of the mobile terminal.

18. The mobile terminal of claim 15, further comprising a cash memory,
said control circuitry communicating with a cash sales terminal via the infrared-light interface when a purchase is made, storing an amount of cash in said cash memory, receiving a signal from said cash sales terminal via said infrared-light interface where the signal identifies said purchase and indicates an amount paid for the purchase, canceling an amount equal to the amount indicated in said signal from said cash memory and storing the cancelled amount in said expense record memory.

19. The mobile terminal of claim 14, wherein said control circuitry further performs receiving from said bank an e-mail which identifies an income source and indicates an amount of income and an amount deducted from said amount of income, and updating said savings memory with said amount of income and storing the deducted amount in said expense record memory
